(19) United States
(12) Patent Application Publication
(10) Pub. No.: US 2006/0137556 A1
(43) Pub. Date: Jun. 29, 2006

(54) Process for making combustion enhancement device for internal combustion engines

(76) Inventors: Seiichi Sengoku, Ashiya City (JP); Tohru Uchida, Gifu City (JP)

Correspondence Address: Michael W. Starkweather;Suite 200, 9035 South, 1300 East, Sandy, UT, 84094, US

(21) Appl. No.: 11/026,173

(22) Filed: Dec. 29, 2004

(51) Int. Cl. B41F 33/00

(52) U.S. Cl. 101/483

(57) ABSTRACT

There is a process to make a combustion enhancement device for internal combustion engines. A base material is provided. A substance, emitting alpha and/or beta particles, is printed in a pattern wherein the pattern restricts disposition of the substance from designated cutting areas. The base material is cut in the designated cutting areas. Tabs, having edges cut in the designated cutting areas, are bent to approximately ninety degrees from the plane of the base material such that the substance faces inwardly.

### BACKGROUND OF THE INVENTION

1. Field of the Invention

The present invention relates to a process for making combustion enhancement devices for internal combustion engines, specifically combustion enhancement devices having a coating of material containing an element emitting alpha or beta particles.

2. Description of the Related Art

In internal combustion engines, air is mixed with fuel and then ignited in a combustion chamber wherein changes to a gas and expands. The resultant gas includes diverse pollutants such as carbon monoxide, hydrocarbons, and nitrogen oxides. Incomplete combustion is linked to pollutants in the resultant gas, both as a cause and a symptom. Incomplete combustion also decreases the efficiency and power of the internal combustion engine.

Typically, intake air fed into internal combustion engines is not in a state to facilitate ideal combustion. Ideally, air to be used in an internal combustion engine includes a balance of positive and negative ions. However, the air usually fed into internal combustion engines has an overabundance of positive ions, which interfere during the combustion process and cause incomplete combustion.

Negative ions may be added to air by exposing the air to alpha and/or beta particles. However, the negative ions do not continue to exist for very long, so the air must be mixed with fuel and combusted fairly quickly after being exposed to the alpha and/or beta particles. Therefore the source of the alpha and/or beta particles must be sufficiently close to the point of mixture of the fuel and the air. Further the air must be sufficiently exposed to the source of the alpha and/or beta particles.

One natural source of alpha and/or beta particles is ore containing rare earth metals. This ore may be ground into particles or a powder and combined with base materials to form combustion enhancement devices. These combustion enhancement devices may then be attached to internal combustion engines. Power, air purity, and engine performance are then substantially enhanced by the combustion enhancement device.

However, there are difficulties in adapting the base materials to internal combustion engines. Depending upon the point of contact with an air intake component of the internal combustion engine and the intended mode of exposing the alpha and/or beta particles to the air intake, the combustion enhancement device may be required to be cylindrical, spherical, conical, flat, rough, or any manner of shape and form. Because of the properties of the ore, affixing the ore to the base materials and then forming those base materials to the shapes required becomes problematic. In particular, the ore, being a hard grit-like substance, may damage machinery used in the manufacturing process of the combustion enhancement device. Additionally, the ore may be wasted during application to the material, and during further processing of the base material.

For example, it may be inconvenient to apply ore to an already shaped base material. In another example, applied ore may be knocked, broken, or rubbed off certain areas during adaptation and may then be wasted.

Also, considerable time may be spent drying the ore and bonding material after it has been applied to the surface of the base material, especially where the base material coated with the ore by a dipping or flow coat method. Further, the surfaces must be manipulated in such a way to expose as much of the air as possible to a significant density of alpha and/or beta particles.

What is needed is a process to manufacture efficient and effective combustion enhancement devices quickly, cheaply and in a way that reduces damage to the manufacturing equipment.

Incorporated by reference herein is Japanese utility model U3082307 “Combustion Improvement through Effective Equipment” to Seiichi Sengoku.

### SUMMARY OF THE INVENTION

The present invention has been developed in response to the present state of the art, and in particular, in response to the problems and needs in the art that have not yet been fully solved by currently available liner supports. Accordingly, the present invention has been developed to provide a process for making a combustion enhancement device for internal combustion engines.

The process includes providing a base material, preferably aluminum and preferably approximately 0.1 mm to 0.6 mm thick, having a first side and a second side. Additionally the process includes defining a plurality of designated cutting areas on the base material, preferably each designated cutting area includes a first cut line and a second cut line substantially perpendicular to the first cut line. A plurality of tabs are formed when the aluminum base material is cut in each designated cutting area, wherein the first cut line and the second cut line preferably define four triangular tabs of approximately equal size wherein a square hole is formed in the base material when the four triangular tabs are bent in the direction of the second side. Preferably the square hole comprises a range of area of approximately one hundred square millimeters to approximately four hundred square millimeters.

The process further includes printing a substance which emits alpha and/or beta particles, the substance preferably including a rare earth element, on the first side of the aluminum base material. Preferably, the printing step uses a silk screen type printing method. Further, it is preferred that the rare earth substance comprises fifty percent or more of fine particles of a natural ore containing a rare earth metal and fifty percent or less of mineral paint.

In the process it is preferred that the silk screen type printing method includes a pattern configured to prohibit deposition of the rare earth substance on the designated cutting area and to allow deposition on the remainder. A plurality of tabs may be formed by cutting each designated cutting area. An array of holes may be formed by bending each tab in the direction of the second side wherein an angle between a second side plane of each tab and a second side plane of the second side is approximately ninety degrees. Further, a section cutting area may be defined wherein the pattern is further configured to prohibit deposition of the rare earth substance on the section cutting area and wherein the base material may be separated into a plurality of separate units after cutting the section cutting area.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of an array of square holes comprising a combustion enhancement device according to one embodiment of the invention.

FIG. 2 illustrates a flow chart for making a combustion enhancement device according to one embodiment of the invention;

FIG. 3 illustrates an exploded side view of printing a substance on a base material according to a pattern according to one embodiment of the invention;

FIG. 4 is a planar view of a cut and severed unit of a combustion enhancement device having flaps yet to be bent according to one embodiment of the invention;

FIGS. 5A and 5B illustrate exemplary cutting area shapes together with examples of printing area shapes according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

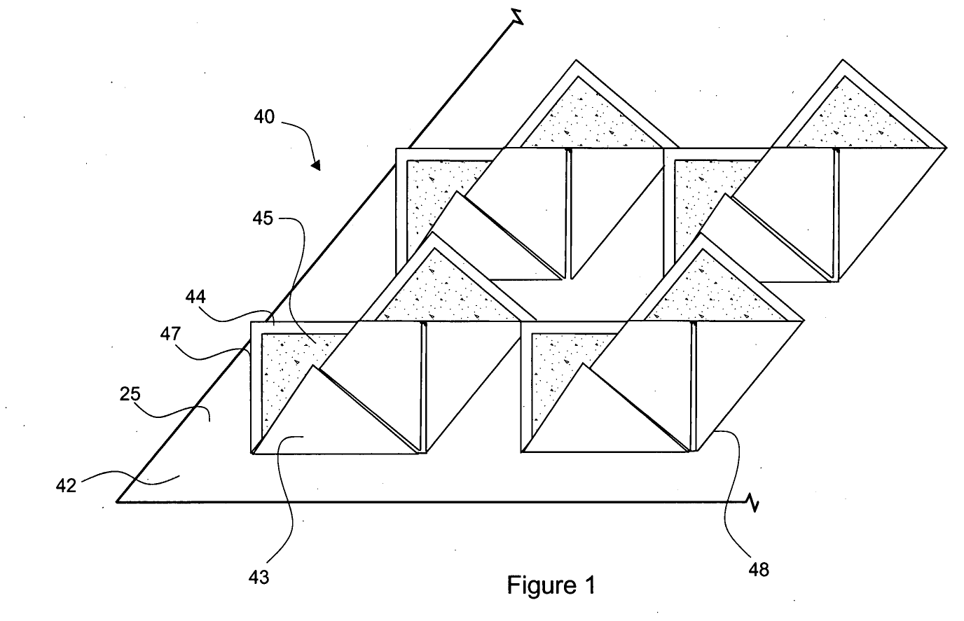

FIG. 1 is a perspective view of a portion of an array of square holes comprising a combustion enhancement device which may be produced according to one embodiment of the invention. The portion 40 includes the base material 25 and shows the top side 42 of the base material 25 not having substantial amounts of the substance 45 bonded to the base material 25. The tabs 47 each comprise a first side, or face, 44 including substance 45 thereon and a second side, or face, 43 being substantially free of substance 45. Preferably, there is approximately a ninety-degree angle 48 between the second side 43 of the tab 47 and the top side 42 of the base material 25. Also of note, the substance 45 may or may not completely cover the first side 44 of the tab 47, therefore there may be a margin free of substance 45 along the edge of the tab 47.

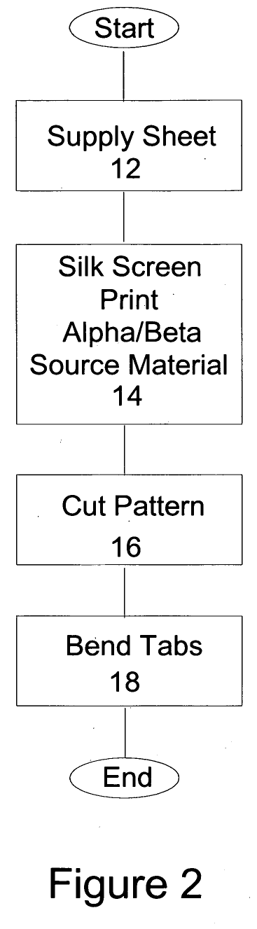

FIG. 2 illustrates a flow chart for making a combustion enhancer according to one embodiment of the invention. The process comprises supplying 12, printing 14, cutting 16 and bending 18. A base material 25 (See FIG. 1) of material is supplied 12. The base material 25 preferably has properties permitting it to withstand high velocity air flow and the accompanying heat without significant deformity. Additionally, the base material 25 should be bendable and should be such that an ore paint can bond to one surface of the base material 25. Exemplary materials include aluminum, resin, and composites.

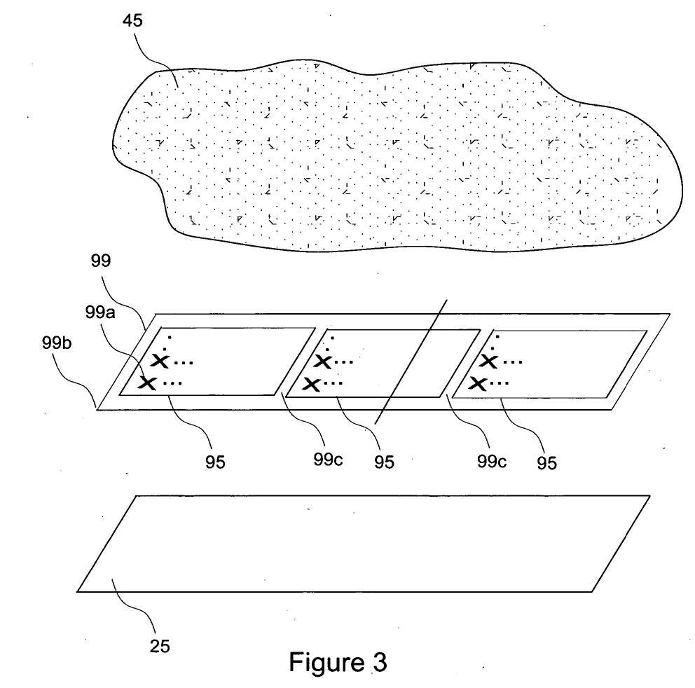

The base material 25 is submitted to printing 14, preferably a silk screen type printing. The silk screen type printing prints a substance 45 (See FIG. 1) on at least one planar surface of the base material 25. The substance 45 comprises a material which is a source of alpha and/or beta particles as well as a matrix bonding material used to affix the source material to one planar surface of the base material 25. Preferably, the substance 45 comprises about 50% or more ore material and 50% or less matrix bonding material. Ores containing rare earth metals may be used in the substance as a source of alpha and/or beta particles. A pattern 99 (See FIG. 3) is used during the silk screen type printing 14 wherein the substance 45 is printed 14 only in defined areas. The areas not to be printed 14 upon are designated cutting areas. The designated cutting areas are defined such that, when the base material 25 is later cut 16, the cutting machinery cuts 16 through the base material 25 avoiding significant contact with the substance 45.

The base material 25 is cut 16 within the designated cutting areas. The cuts define tabs 47 (See FIG. 1) of the base material 25 having edges substantially devoid of the substance 45 but having substantial quantities of the substance 45 within the body of each tab 47. The tabs 47 may be of any shape or size and may have complicated edges or may be as simple as a pair of tabs defined by bending the edges of a single straight cut.

The tabs 47 are bent so as to have a substantially planar portion of each tab 47 at an angle 48 (See FIG. 1) with plane defined by the unbent portions of the base material 25. The tabs 47 are bent such that the surface whereupon a substance 45 is bonded defines an outside, larger angle, and a surface whereupon there is no substance 45 bonded defines a smaller inside angle 48, where the original state of the unbent tab 47 had both angles being one hundred and eighty degrees where the tab 47 lay parallel to the plane of the base material 25. In this way the tab face 44 (See FIG. 1) having the bonded substance 45 will face a hole 46 (See FIG. 1) created by the bending of the tab 47 away from the plane of the base material 25. Where multiple tabs 47 are adjacent, as each adjacent tab 47 is bent away from the plane of the base material 25 a hole 46, formed by the bending away of the base material 25 of the tab 47, enlarges and the substance 45 bonded faces 44 of the adjacent tabs 47 will preferably face one another. The faces 44 and holes 46 thereby preferably form channels wherein air may pass and be exposed to alpha and/or beta particles.

FIG. 3 illustrates an exploded side view of printing 14 (See FIG. 2) a substance 45 on a base material 25 according to a pattern 99 according to one embodiment of the invention. There is a base material 25 and a substance 45. Between the base material 25 and the substance 45 is disposed a pattern 99, preferably a screened or silk-screen type pattern. The screened pattern 99 permits printing 14 of the substance 45 on the base material 25 only in those locations not defined by the pattern 99 as non-printing areas, for example 99a, 99b and 99c, and restrict printing from at least one non-printing area. The optional non-printing area 99a is shaped to correspond to a cutting area required to make tabs 47. The optional non-printing area 99b provides a border around the base material 25 wherein the substance is not printed. The optional non-printing area 99c is shaped to correspond to a cutting area required to separate combustion enhancement units 95.

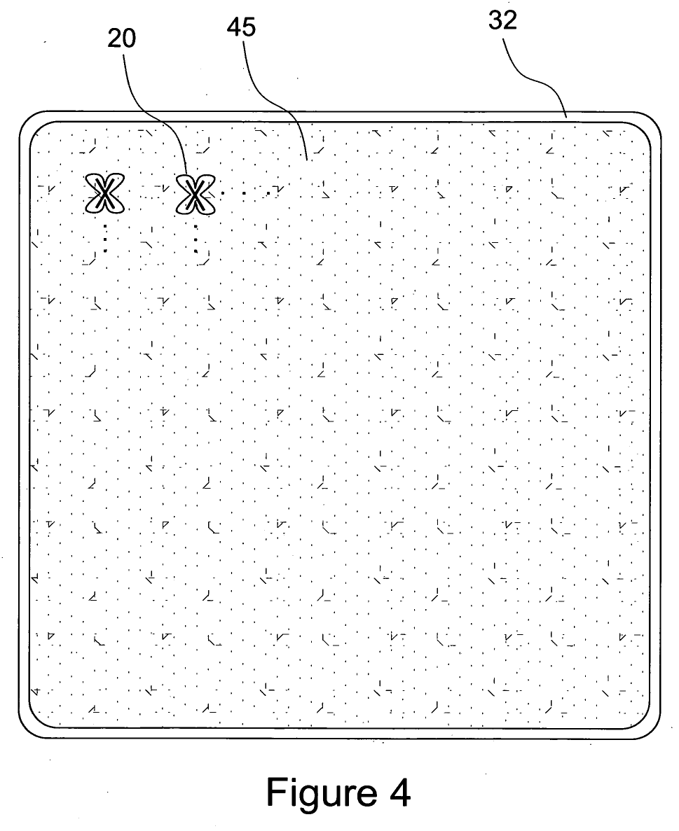

FIG. 4 is a planar view of a cut and severed unit, such as would be formed by cutting a non-printing area 99c, having tabs 47 yet to be bent according to one embodiment of the invention. The unit 30 may have been cut and severed from a larger base material as shown in FIG. 3. In the shown unit 30, tab set 20 is repeated in an array on the plane of the unit 30. The border 32 of the unit 30 is substantially clear of the bonded substance 24, wherein the non-printing areas 99b and or 99c restricted printing of the substance 45 from the border 32 of the unit 30.

As shown in FIG. 4, each tab set 20 is configured to be substantially free of substance 45 in the X-shaped cutting areas. Therefore tab sets 20 may each be cut, stamped, or scored without the substance substantially interacting in the process at the cut, stamp, or scoring locations. Additionally, the array of tab sets 20 are configured in this embodiment of the present invention to form a structure similar to a mesh or lattice, wherein the array is substantially spread over the whole of the base material 25.

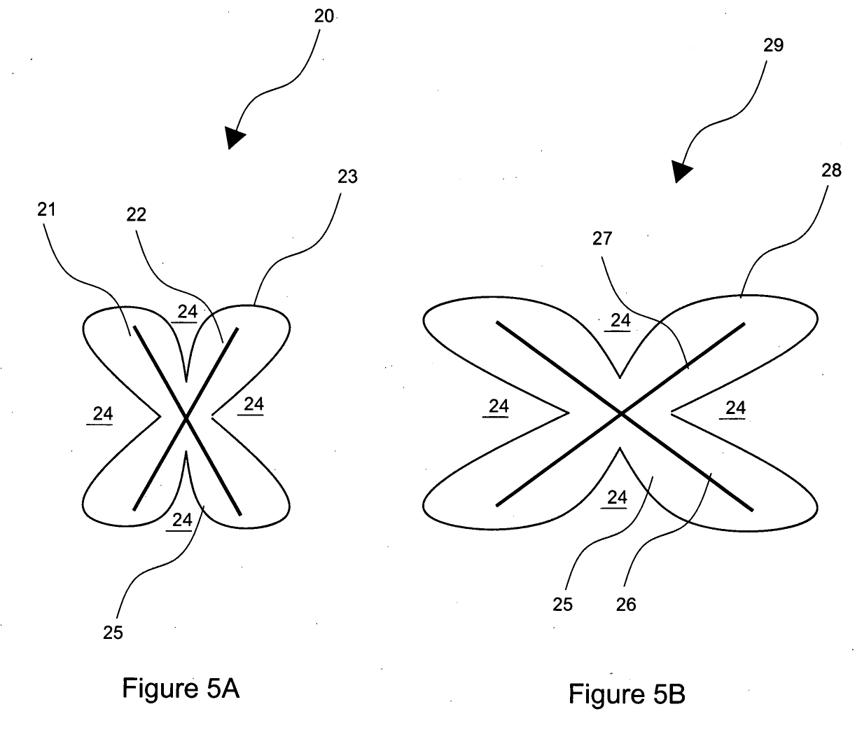

FIG. 5A illustrates an exemplary cutting area shape together with an example of a printing area shape according to one embodiment of the invention. There is a tab set 20 including two cross cuts 21 and 22 generally forming an X shape. The cuts 21 and 22 may or may not have been formed by two separate cutting motions. Further included in tab set 20 is a coating of the substance 24 bonded to the base material 25. There is a border 23 defining the area of the base material 25 not having substance bonded thereon.

FIG. 5B illustrates an alternative exemplary cutting area shape together with an example of a printing area shape according to one embodiment of the invention. There is a tab set 29 including two tangential crescent cuts 26 and 27 generally forming an X shape. The cuts 26 and 27 may or may not have been formed by two separate cutting motions. Further included in tab set 29 is a coating of the substance 24 bonded to the base material 25. There is a border 28 defining the area of the base material 25 not having substance bonded thereon.

Comparing FIG. 1 with 5A and 5B, the cuts 21, 22, 26, and 27 become the edges of the resultant tabs 47 after the tabs are bent 16. Four adjacent tabs 47 are formed when the base material 25 is cut in an X shape and bent 16. The four adjacent tabs then define the boundaries of a generally square-shaped hole 46. The adjacent tabs 47, together with the hole 46 preferably form a channel wherein air passing through the channel may come in significant contact with alpha and or beta particles emitted from the substance 45 coating the inner surfaces 44 of the adjacent tabs 47, which inner surfaces 44 may be considered to be the inner walls of the channel.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the illustrated tab sets are generally X shaped before bending it is envisioned that the tab sets may be of any shape or size. Further, while the tab sets in a unit are shown as substantially identical, it is envisioned that there may be diverse tab sets within a single unit.

Additionally, although the figures illustrate square holes, it is envisioned that any shape hole may be produced. Further, the angle made by the tabs and the holes may be sharp or rounded.

Also, the printing may be accomplished by any known means of printing, using a pattern to define print and non-print areas for deposition of the substance, including but not limited to positive or negative silk screen type printing.

It is also envisioned that the base material may be further manipulated to adapt and attach to an air filter on an internal combustion engine. For example, the base material may be wrapped around a cylindrical air filter or may be bent at an angle to attach to a non-flat air filter. Further, several units may be attached with clips, omega clips for example, wherein the several units together accommodate the size of the air filter.

It is expected that there could be numerous variations of the design of process of this invention. An example is that the order of the steps may or may not coincide with the order listed within the claims. Another example is that some steps may be done with machinery and some without, or all with or all without. Further, a single piece of machinery may do all the required steps, or different facilities may be required to accomplish all the steps where the unfinished pieces may need to be shipped to diverse locations to complete the process.

Finally, it is envisioned that the components of the device may be constructed of a variety of materials. The base material may be metal or resin or composite. The alpha and/or beta particle source may be a rare earth metal or some other known source of alpha and/or beta particles.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A process for making a combustion enhancement device for internal combustion engines comprising:
providing a base material having a first side and a second side;
printing a substance containing at least one rare earth component on the first side of the base material by using a pattern configured to prohibit deposition of the substance on a designated cutting area and to allow deposition on a remainder;
forming a tab by cutting the designated cutting area; and
bending the tab in the direction of the second side wherein an angle between a second side plane of the tab and a second side plane of the second side is approximately ninety degrees.

2. The process of claim 1, wherein the printing is a silk-screen type printing.

3. The process of claim 1, wherein the substance comprises:
about fifty percent or more of particles of an ore containing a rare earth metal; and
about fifty percent or less of a matrix bonding material selected from the group consisting of mineral paint and organic/inorganic compound paint.

4. The process of claim 1, further comprising:
forming a plurality of tabs by cutting the designated cutting area; and
bending each tab in the direction of the second side wherein an angle between a second side plane of each tab and a second side plane of the second side is approximately ninety degrees.

5. The process of claim 1, wherein the base material comprises aluminum and wherein the base material is approximately 0.1 mm to 0.6 mm thick.

6. The process of claim 1, wherein the designated cutting area comprises:
a first cut line; and
a second cut line substantially perpendicular to the first cut line wherein the first cut line and the second cut line together generally form an X shape.

7. The process of claim 4, further comprising defining a second cutting area wherein the pattern is further configured to prohibit deposition of the substance on the second designated cutting area and wherein the base material may be separated into a plurality of separate units after cutting the second designated cutting area.

8. The process of claim 6, wherein the first cut line and the second cut line define four triangular tabs of approximately equal size wherein a square hole is formed in the base material when the four triangular tabs are bent in the direction of the second side.

9. The process of claim 8, comprising doing the listed steps in parallel such that an array of square holes are formed on the base material.

10. The process of claim 4, wherein the plurality of tabs is arranged in an array of similarly shaped tabs.

11. A process for making a combustion enhancement device for internal combustion engines comprising:
printing a substance substantially in a deposition area on a first side of a base material and substantially not in a cutting area, wherein the deposition area and the cutting area are defined by a pattern, wherein the substance includes a component emitting particles selected from the group consisting of alpha particles and beta particles;
cutting the base material substantially in the cutting area; and
forming holes in the base material by bending cut portions formed during the cutting wherein faces of the cut portions formerly comprising the first side of the base material and having the substance deposited thereupon face inwardly towards each respectively formed hole.

12. The process of claim 11, wherein printing is done by a silk screen type apparatus and the holes are formed in an array defined by a silk screen type pattern.

13. The process of claim 12, wherein the substance comprises:
base paint material selected from the group consisting of mineral paint and organic/inorganic compound paint; and
particles of natural ore containing an element emitting particles selected from the group consisting of alpha particles and beta particles.

14. The process of claim 13, wherein the element emitting particles selected from the group consisting of alpha particles and beta particles is a rare earth element.

15. The process of claim 14, wherein the holes are generally square shaped.

16. The process of claim 15, wherein the cut portions are formed by a generally X-shaped cut in the base material.

17. The process of claim 16, wherein the cut portions are bent substantially perpendicular to the plane of the base material.

18. The process of claim 17, wherein the base material is further cut into array sections configured to be attached to air filters of internal combustion engines.

19. The process of claim 18, wherein the area defined by the silk screen type pattern wherein the silk screen type apparatus will not deposit material further includes a cutting region necessary to cut the base material into the array sections.

20. A process for making a combustion enhancement device for internal combustion engines comprising:
providing an aluminum base material, approximately 0.1 mm to 0.6 mm thick, having a first side and a second side;
using a pattern to define a plurality of designated cutting areas on the base material, wherein each designated cutting area includes a first cut line and a second cut line substantially perpendicular to the first cut line, wherein a plurality of tabs are formed when the aluminum base material is cut in each designated cutting area, wherein the first cut line and the second cut line define four triangular tabs of approximately equal size wherein a square hole is formed in the base material when the four triangular tabs are bent in the direction of the second side, wherein the square hole comprises a range of area of approximately 100 square millimeters to approximately 625 square millimeters;
printing a rare earth substance on the first side of the aluminum base material using a silk screen type printing method, wherein the rare earth substance comprises:
about fifty percent or more of fine particles of an ore containing a rare earth metal; and
about fifty percent or less of mineral paint, wherein the silk screen type printing method includes a pattern configured to prohibit deposition of the rare earth substance on the designated cutting area and to allow deposition on the remainder;
forming a plurality of tabs by cutting each designated cutting area; and
forming an array of holes by bending each tab in the direction of the second side wherein an angle between a second side plane of each tab and a second side plane of the second side is approximately ninety degrees; and
using a pattern to define a section cutting area wherein the pattern is further configured to prohibit deposition of the rare earth substance on the section cutting area and wherein the base material may be separated into a plurality of separate units after cutting the section cutting area.
